(19) United States
(12) Patent Application Publication
(10) Pub. No.: US 2018/0059774 A1
(43) Pub. Date: Mar. 1, 2018

(54) DISPLAY APPARATUS AND CONTROL METHOD THEREOF

(71) Applicant: SAMSUNG ELECTRONICS CO., LTD., Suwon-si (KR)

(72) Inventors: Yong-hoon LEE, Yongin-si (KR); So-jeong PARK, Suwon-si (KR); Jun-yong PARK, Suwon-si (KR); In-jee SONG, Seoul (KR); Sul-hee YANG, Seoul (KR); Soo-yeon HAN, Suwon-si (KR); Soo-hwan KIM, Seongnam-si (KR); Won-pil KIM, Suwon-si (KR); Dae-hyun NAM, Anyang-si (KR); Min-kyung YOON, Suwon-si (KR); Jae-eun CHEONG, Yangju-si (KR)

(73) Assignee: SAMSUNG ELECTRONICS CO., LTD., Suwon-si (KR)

(21) Appl. No.: 15/392,583

(22) Filed: Dec. 28, 2016

(30) Foreign Application Priority Data
Aug. 26, 2016 (KR) 10-2016-0109215

(51) Int. Cl. G06F 3/01; G09G 5/10; G06F 3/0481; G09G 5/14

(52) U.S. Cl. CPC G06F 3/011; G09G 5/10; G06F 3/0481; G09G 5/14; G09G 2360/144; G09G 2354/00; G09G 2320/10; G09G 2320/08; G06F 2203/04803

(57) ABSTRACT

A display apparatus includes a display, a sensor configured to sense a user, and a processor configured to control, based on the sensed values of the sensor, the display to operate in one mode among a first mode for outputting information-providing content on the display, a second mode for providing a mirror function with the display, and a third mode for providing UI screen in which user interaction is performed.

### CROSS-REFERENCE TO RELATED APPLICATIONS

This application claims priority from Korean Patent Application No. 10-2016-0109215, filed on Aug. 26, 2016 in the Korean Intellectual Property Office, the disclosure of which is incorporated herein by reference in its entirety.

### BACKGROUND

### 1. Field

Apparatuses and methods consistent with exemplary embodiments relate to a display apparatus and a control method thereof, and more specifically, to a display apparatus for providing a mirror function and a control method thereof.

### 2. Description of the Related Art

Recently, a mirror display gathers increasing attention with the introduction of an internet of things (‘IoT’).

The large clothing outlets are currently the places where one can easily see a mirror display. A customer may virtually put on clothes using the mirror, instead of directly wearing the clothes in a fitting room. Further, the mirror may provide services such as directly suggesting clothes that would look good on the consumer. In addition, the mirror display is developed so as to be easily used at homes.

However, considering that the mirror display provides both a mirror function and a display function, it may be necessary to automatically provide a proper mode by accurately analyzing an intention of a user approaching the mirror display, for more convenient use of the mirror display apparatus.

### SUMMARY

Exemplary embodiments may overcome the above disadvantages and other disadvantages not described above. Also, exemplary embodiments are not required to overcome the disadvantages described above, and an exemplary embodiment may not overcome any of the problems described above.

Exemplary embodiments provide a display apparatus with a mirror function of properly providing an output mode meeting user needs based on a sensed value of a user and a control method thereof.

According to an aspect of an exemplary embodiment, there is provided a display apparatus including a display; a sensor configured to sense a user; and a processor configured to control, based on sensed values of the user, the display to operate in one mode from among a first mode, a second mode, and a third mode, wherein the first mode includes outputting information-providing content on the display, the second mode includes providing a mirror function on the display, and the third mode includes providing a user interface (UI) screen in which user interaction is performed.

The second mode may further include providing passive content on a region of the display and providing the mirror function on another region of the display, and the third mode may include providing the UI screen including active content on a region of the display and providing the mirror function on another region of the display.

The sensor may be further configured to sense an approaching speed of the user, and the processor may be further configured to, control the display to operate in the first mode when the sensed approaching speed is less than a preset threshold speed, and control the display to operate in the second mode or the third mode when the sensed approaching speed is greater than or equal to the preset threshold speed.

The processor may be further configured to control the display to operate in the first mode when at least one of a duration of sensing the user and a duration of using the display is less than a preset threshold time, and control the display to operate in the second mode or the third mode when at least one of the duration of sensing the user and the duration of using the display is greater than or equal to the preset threshold time.

The sensor may be further configured to sense values of at least one from among a current position of the user, a position change of the user, an approaching speed of the user, an action of the user, a duration of sensing the user and a duration of using the display, and the processor may be further configured to c control the display to operate in one of the first to third modes based on the sensed values from the sensor.

The sensor may be further configured to sense ambient illumination, and the processor may be further configured to adjust at least one from among a power switch and an intensity of a light based on the sensed ambient illumination in the second mode or the third mode.

The processor may be further configured to provide the mirror function on at least a region of the display based on an approaching distance of the user in the second mode, and adjust a size of the region as the user approaching distance is changed.

The processor may be further configured to control the display to operate in a fourth mode including providing an alarm based on the alarm information received from an external user terminal, and control the display to operate automatically in the first mode in response to the fourth mode being completed.

The processor may be further configured to, when connected with an external user terminal, control the display to operate in the second mode or the third mode based on a user command input state of the external user terminal.

According to an aspect of another exemplary embodiment, there is provided a control method of a display apparatus, the control method including: sensing a user; and operating, based on sensed values of the user, in one mode from among a first mode, a second mode, and a third mode, wherein the first mode includes outputting information-providing content on a display, the second mode includes providing a mirror function on the display, and the third mode includes providing a user interface (UI) screen in which user interaction is performed.

The second mode may include providing passive content on a region of the display and providing the mirror function on another region of the display, and the third mode may include providing the UI screen including active content on a region of the display and providing the mirror function on another region of the display.

The sensing the user may include sensing an approaching speed of the user, and operating in the first mode when the sensed approaching speed is less than a preset threshold speed, and operating in the second mode or the third mode when the sensed approaching speed is greater than or equal to the preset threshold speed.

The controlling the output state of the display may include operating in the first mode when at least one from among a duration of sensing the user and a duration of using the display is less than a preset threshold time, and operating in the second mode or the third mode when at least one from among the duration of sensing the user and the duration of using the display is greater than or equal to the preset threshold time.

The sensing the user may include sensing values of at least one from among a current position of the user, a position change of the user, an approaching speed of the user, an action of the user, a duration of sensing the user and a duration of using the display, and the controlling the output state of the display may include operating in one of the first to third modes based on the sensed values.

The method may include sensing ambient illumination; and adjusting at least one from among a power switch and an intensity of a light based on the sensed ambient illumination in the second mode or the third mode.

The method may include providing a mirror function on at least a region of the display based on the user approaching distance in the second mode, and adjusting a size of the region as the user approaching distance is changed.

The method may include operating in a fourth mode including providing an alarm based on the alarm information received from an external user terminal, and operating automatically in the first mode in response to the fourth mode being completed.

The method may include, when connecting with an external user terminal, operating in the second mode or the third mode based on a user command input state of the external user terminal.

According to the above-described exemplary embodiments, because at least one of the mirror function and the display function may be provided in proper time according to user needs, user convenience is enhanced.

### BRIEF DESCRIPTION OF THE DRAWINGS

The above and/or other aspects of exemplary embodiments will be more apparent with reference to the accompanying drawings.

FIGS. 1A to 1D are diagrams illustrating a display apparatus according to an exemplary embodiment.

FIG. 2 is a diagram illustrating a configuration of a display apparatus according to an exemplary embodiment.

FIGS. 3A and 3B are diagrams illustrating a display according to an exemplary embodiment.

FIG. 4 is a block diagram illustrating a configuration of the display apparatus illustrated in FIG. 2, according to an exemplary embodiment.

FIGS. 5A to 5E are diagrams illustrating display output states according to one or more exemplary embodiments.

FIG. 6 is a diagram illustrating a screen output state of a second mode according to an exemplary embodiment.

FIG. 7 is a diagram illustrating a screen output state of a third mode according to an exemplary embodiment.

FIGS. 8A to 8D are diagrams illustrating a screen output state according to an exemplary embodiment.

FIG. 9 is a diagram illustrating a mode change process according to an exemplary embodiment.

FIGS. 10A and 10B are diagrams illustrating a method for providing content according to an exemplary embodiment.

FIGS. 11 and 12 are diagrams illustrating a method for providing mirroring content according to an exemplary embodiment.

FIGS. 13A and 13B are diagrams illustrating a method for controlling a speaker according to an exemplary embodiment.

FIG. 14 is a flowchart illustrating a method for controlling a display apparatus according to an exemplary embodiment.

### DETAILED DESCRIPTION OF EXEMPLARY EMBODIMENTS

Exemplary embodiments will be described below in greater detail with reference to the accompanying drawings.

In the following description, same drawing reference numerals are used for the same elements even in different drawings. The matters defined in the present disclosure, such as detailed construction and elements, are provided to assist in understanding the exemplary embodiments. However, exemplary embodiments may be carried out without those specifically defined matters. Also, well-known functions or constructions may not be described in detail if they would obscure the present disclosure with unnecessary detail.

Expressions such as “at least one of,” when preceding a list of elements, modify the entire list of elements and do not modify the individual elements of the list.

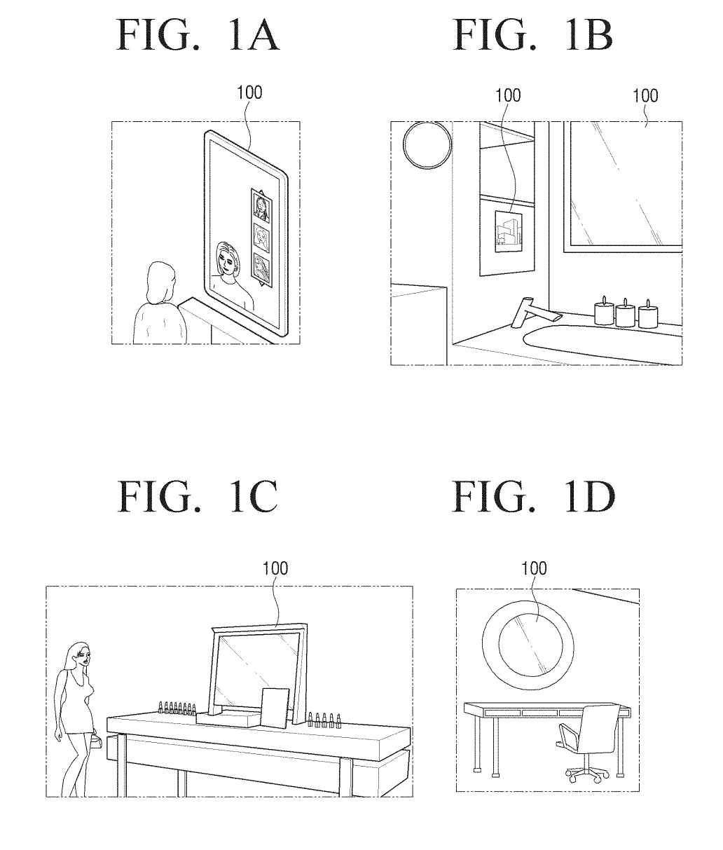

FIGS. 1A to 1D are diagrams illustrating a display apparatus according to an exemplary embodiment.

Referring to FIGS. 1A to 1D, the display apparatus 100 may be implemented in various forms of a mirror display apparatus set in various places in need of a mirror, which can deliver information while providing a mirror function. As used herein, ‘mirror display’ is a compound word of a word, ‘mirror,’ indicating a mirror and a word, ‘display,’ indicating a job of expressing information visually.

Such mirror display provides at least one of the mirror function and the display function according to user needs at proper time. Thereby, according to one or more exemplary embodiments, a user may be provided with an output mode suitable for his or her intention, after various factors that can reflect user needs are taken into consideration, as will be explained below with reference to one or more exemplary embodiments and drawings.

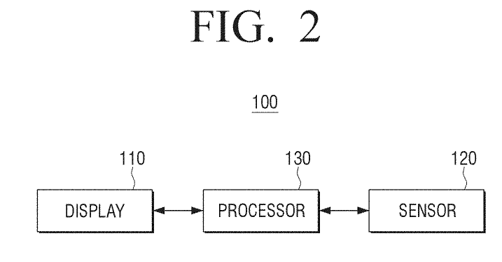

FIG. 2 is a diagram illustrating configuration of a display apparatus according to an exemplary embodiment.

Referring to FIG. 2, the display apparatus 100 includes a display 110, a sensor 120, and a processor 130.

In an example, the display apparatus 100 may be implemented to be smart TV or monitor, but not limited herein. The display apparatus 100 may be implemented to be various forms of devices provided with the display function, such as large format display (LFD), digital signage, digital information display (DID), video wall, projector display, and so on.

The display 110 may be implemented to be a mirror display that provides the mirror function and the display function.

The display 110 may be implemented to be a liquid crystal display panel (LCD), an organic light emitting diodes (OLED), a liquid crystal on silicon (LCoS), a digital light processing (DLP), and so son, although not limited thereto. Further, the display 110 may be implemented to be a transparent display formed from a transparent material to display information. Meanwhile, in some examples, the display 110 may be implemented to be a touch screen type forming an interlayer structure with a touch pads. In these examples, the display 110 may be used as user interface as well as an output device.

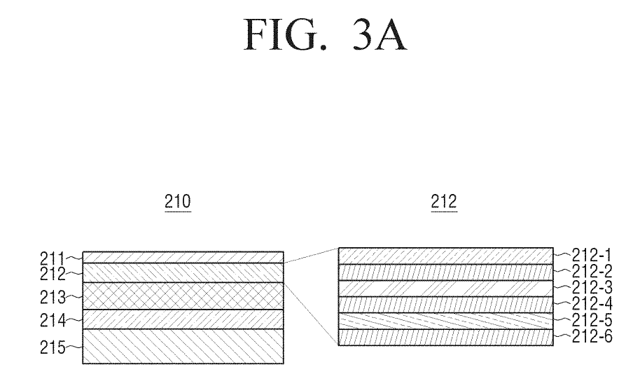

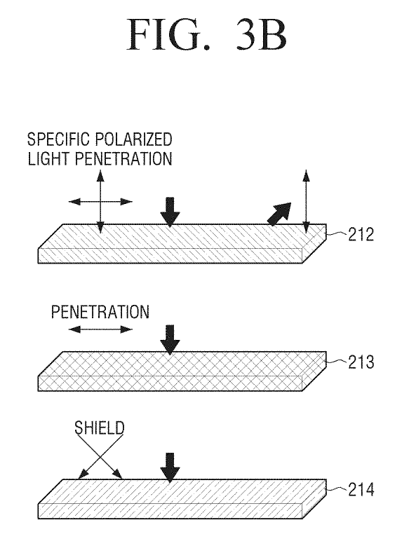

According to an exemplary embodiment, the display 110 may be implemented to be the mirror display, and the mirror display may be implemented to be a type in which a mirror film is added to a related normal display. FIG. 3A illustrates the display as a liquid crystal display among various display types. The liquid crystal display, or LCD, may operate according to a principle in which desired image information is obtained as a backlight generates a light and the light penetrates among the liquid molecules.

The LCD 210 may be mainly divided into a coating film 211, an upper polarized plate 212, a liquid crystal display panel 213, a lower polarized plate 214, and a backlight 215. The upper/lower polarized plates 212, 214 may perform a function of discriminating the light, when the light radiating from the backlight 215 is illuminating while penetrating through the liquid crystal. Further, the liquid crystal display panel 213 positioned between the upper/lower polarized plates 212, 214 may include an illuminating material.

According to an exemplary embodiment, a mirror film 212-1 for providing the mirror function may be positioned on the upper polarized plate 212 that discriminates the light. The upper polarized plate 212 may be composed of TAC (Tri-Acetyl-Cellulose) 212-2, 212-4, 212-6, PVA 212-5, and the mirror film 212-3. The TAC (Tri-Acetyl-Cellulose) is a film playing a role of protecting the polarized plate, and the PVA (Polyvinyl Alcohol) is a film playing a role of discriminating the light at the polarized plate. The reason why the mirror film 212-3 is positioned on the polarized plate for serving a role of filtering the light mainly lies on the basic properties of a mirror. A mirror reflects the light. Accordingly, by using the polarized plate to reflect a specific light and pass a specific light, it is possible to provide both the roles of the display and the mirror simultaneously.

When the mirror function is provided on a certain region of the screen, only the backlight 215 of the partial region may drive in off-state based on the local dimming.

However, the mirror display apparatus configuration illustrated in FIG. 2 is an example, and exemplary embodiments are not limited to the above example. Any configuration may be used to provide the mirror function and display function.

The sensor 120 may sense a user.

Specifically, the sensor 120 may sense whether a user is present in front of the display apparatus 100, an approaching speed of a user, a current position of a user, a direction (or angle) of a user position, a change of a user position within a preset time range, and a user action. In an example, the sensor 120 may be implemented to be various types of sensors that can sense the user. For example, the sensor 120 may include at least one of a proximity sensor, a passive infrared sensor (PIR), a pin hole sensor, a pin hole camera, an infrared body sensor, a CMOS image sensor, a thermal sensitive sensor, an optical sensor, and a motion sensor. For example, when the sensor 120 is implemented to be the infrared body sensor (e.g., infrared ray time of flight (IR ToF) sensor), the sensor 120 may sense presence/absence of a user, an approaching speed, a current position, a position change, and so on, based on a time for an emitted light to be reflected and received.

Further, the sensor 120 may include at least one sensor that can sense an ambient illumination, an ambient temperature, and a direction of incident light. In this case, the sensor 120 may be implemented to be an illumination sensor, a temperature sensor, an optical sensing layer, a camera, and so on. For example, the illumination sensor may be arranged within a glass provided on the display 110, in which case a sensing function may be controlled to perform normal operations even within glasses with algorithms that can compensate transmittance/reflectance of the glasses provided on the display 110.

Besides, the sensor 120 may further include various sensors for operation of the display apparatus 100 such as touch sensor, acceleration sensor, geomagnetic sensor, and so on.

The processor 130 may control the overall operations of the display apparatus 100. The processor 130 may include one or more of a central processing unit (CPU), a controller, an application processor (AP), a communication processor (CP), and an ARM processor, or may be defined as corresponding terms. Further, the processor 130 may be implemented to be SoC including the image processing algorithms or implemented to be field programmable gate array (FPGA).

The processor 130 may provide various output modes (or driving modes) based on sensed values from the sensor 120. Specifically, the output state of the display 110 may be controlled so that operation may be in one mode among a first mode for outputting information-providing content, a second mode for providing the mirror function on the display 110, and a third mode for providing UI screen enabling user interaction.

Besides, the processor 130 may additionally provide a fourth mode in which only some elements associated with duration of sensing the user are activated in power-off-state, and a fifth mode in which an alarm function is provided according to preset alarm information.

Herein, the first mode is a mode for outputting an information-providing content on the display 110, which may be entered when it is determined that a user is with an intention of using the display 110 as a general display instead of a mirror.

The processor 130 in the first mode may output various types of information-providing contents, such as, advertisement content, news content, guide content, and so on. In this case, the processor 130 may provide corresponding information when a user's item of interest was previously stored (e.g., item put in a shopping basket by a user), provide advertisement content such as new products based on the user's item of interest, or provide information regarding items that a user may be interested in, based on a user profile. When the display 110 is implemented to be a structure of LCD illustrated in FIG. 3A, the light generated by the backlight 215 may pass through the polarized plate and display an image.

Further, while the processor 130 is outputting information-providing content in the first mode, when a user approaches closer to the display, the processor 130 may enter the second mode, thus zooming out the displayed content to one region of the screen and displaying the same, and providing the mirror function on the rest region.

The second mode is a mode in which the display 110 operates as the mirror display, and may be entered upon determining an intention of using the display 110 as a mirror. When the display 110 is implemented to be a structure of LCD illustrated in FIG. 3A, the backlight 215 may not drive such that, as illustrated in FIG. 3B, by an external light such as natural light, some of the light is passed through the upper polarized plate 212 and some may be reflected against the mirror film 212-3 thus performing the mirror function.

According to an exemplary embodiment, the processor 130 may provide passive content on a certain region in the second mode. For example, the processor 130 may provide a passive form of information such as widget and guide information on a certain region of the screen.

The processor 130 may not receive user interaction in the second mode. As used herein, “not receive user interaction” may include all the circumstances in which user interaction is impossible (e.g., inactivation of the touch panel), or in which the user command can be inputted, but the processor 130 may ignore and may not process the user interaction. It is to be noted that the configuration in which the passive content is provided in the second mode and user interaction is not received may be optional, and accordingly, the second mode may not necessarily perform the above operation.

Meanwhile, the processor 130 may determine an order of the passive contents (e.g., widget) displayed in the second mode according to user context information, when providing the passive contents. Further, while the mirror function is provided on a certain region in the second mode, the processor 130 may change a region for providing the mirror function according to a user position, distance and angle. For example, upon determining that the user is within a distance, the processor 130 may determine an intention to use a front surface as a mirror, and control a black region for providing the mirror function to be increased in size.

Further, the processor 130 may provide the mirror function on at least a certain region of the display 110 based on the user approaching distance in the second mode.

Specifically, the processor 130 may provide the mirror function on a certain region of the screen when being positioned within a preset threshold distance, and provide the mirror function on the entire screen region when being positioned out of the preset threshold distance. Herein, a position and a size of the certain region may be determined based on a region where the user face is positioned, a face size, and so on, although not limited thereto.

Further, the processor 130 may change a size of the mirror region provided in at least a certain region of the display 110 proportionally to the distance at which the user approaches in the second mode. Thus, the processor 130 may increase a size of the mirror region as the distance of user approaching becomes farther, and decrease a size of the mirror region as the distance of user approaching becomes nearer.

Meanwhile, when the processor 130 provides the mirror region on a portion of the display 110, the processor 130 may display the information-providing content on the rest region of the display 110. For example, when the display 110 is implemented to be LCD, based on the local dimming, the processor 130 may cause a region that provides the mirror function to be black, by causing the backlight corresponding to the mirror-function region to be driven in the off-stated.

The third mode may provide the mirror function and also provide UI screen that enables the user interaction on one region. The third mode may be entered upon determining that a user is with an intention to control applications through a button or a remote controller provided on the display apparatus 100, or when specific information is received from an external user terminal. When the display 110 is implemented to be a structure of LCD as illustrated in FIG. 3A, the light generated by the backlight 215 penetrates through the polarized plate and displays an image.

Because user interaction has to be enabled for controlling of UI screen in the third mode, a user interfacing function may be activated. For example, while the touch function is inactive (e.g., when the touch function was inactive in the second mode), upon entering the third mode, the touch function may be automatically activated. For example, a screen or a bezel region may be activated for a touch type button.

The processor 130 may provide active information on UI screen in the third mode. The active information may be information that can be modified according to user interaction. For example, the processor 130 may provide an application form of information such as tutorial information based on the sensed user action, widgets that can be modified, videos, and so on. In one example, the processor 130 may provide the tutorial information based on the sensed user action. For example, the processor 130 may provide information related with the eye make-up when sensing that a user is viewing a mirror and doing the eye make-up, provide information related with a method for tying hairs when sensing that a user action involves tying the hair, and provide information related with a method for squeezing pimples when sensing that a user action involves squeezing pimples. Corresponding tutorial information may be provided in a widget form in which a plurality of information may be browsed with scrolling. When the selected widget is a video image, it may be played through a video player.

Further, based on user context information in the third mode, the processor 130 may change rankings of applications, displayed information, options that can be manipulated through buttons according to the applications, and so on, and provide the modified result. Further, the processor 130 may provide the application that is driven according to user context in the third mode on some or all of the screen.

The fourth mode is a mode in which only some elements associated with duration of sensing the user are activated and the display 110 (or display apparatus 100) is off, and in which only the elements of a sub-processor, IR signal receiver, and a button controller for processing the sensor 120 and sensed values of the sensor 120 are activated in low power state in which the display apparatus 100 is not booted. In this case, the sub-processor may be separately formed from the processor 130 and separately supplied with the power, but not limited thereto. For example, the sub-processor may be implemented as one of the elements within the processor 130, which is supplied with power separately from the other elements of the processor.

Further, the processor 130 may constantly drive the sub-processor in on-state in the fourth mode. However, in some examples, the processor 130 may drive the sub-processor in on-state only for a preset time.

Specifically, the sub-processor may be only activated within a preset time by using a system clock and a clock processor which operate at a maximum power saving mode. Herein, the clock processor may be implemented to be a related microcomputer which stands by for IR signal.

Specifically, with the user pattern-based clock information being previously stored in a clock memory, the clock processor may check a current time, compare it with the clock information stored within the clock memory, and cause the sensor 120 to be activated by driving the sub-processor in on-state only when a preset time approaches.

In an example, the processor 130 in the fourth mode may continuously update the clock memory based on the user context, and drive the sub-processor in on-state upon reaching a corresponding time. For example, the processor 130 may continuously update the clock memory by determining an intention of use of a user based on user context information, e.g., a remote controller signal received from a remote controller, a history of a remote controller signal, an external temperature based on a user position, an ambient temperature, a user action (e.g., eye make-up, hair styling, etc.), time, date, date-related information (e.g., holiday, public holiday, weekdays, weekends, specific day, date associated with acquainted people, etc.), a duration of using the device, a duration of user's being in a position, schedule inputted through another device by a user, an alarm, a reminder, a user related data received from the other sensing device, whether or not being present at a network access point such as another device, and so on, and upon reaching a corresponding time, may drive the sensor in on-state.

Further, according to an exemplary embodiment, the processor 130 in the fourth mode may display current time information, by using a light emitting device disposed on a bezel region in an outer boundary of the display 110. For example, an hour (hr), a minute (min), and a second (sec) may be distinguished and provided in different colors by separately driving LED having different colors (minimum 60×3 color expression) provided on the bezel, and so on. In this case, a sec motion may be provided by using an animation effect moving smoothly with LED 1 fade out-LED 2 fade in. According to another exemplary embodiment, the time information may be displayed on a certain region of the display 110 in the fourth mode. For example, only a certain region may display the time information while the display 110 is in off-state (e.g., analog time form). Otherwise, separate controlling may be performed by using a separate LED or a separate compact display, e.g., by separately including the main display and the clock display. Thus, in the off-state, the processor 130 drive the clock display except for the main display.

Meanwhile, after sensing a user in the fourth mode, when a user is continuously sensed for a preset time within a preset distance range in front of the display apparatus 100, the processor 130 may power-on the display apparatus 100. Further, the processor 130 may power-on the display apparatus 100 by unlocking with a specific gesture recognition in the fourth mode.

Meanwhile, when the sensor 120 is activated in the fourth mode, the processor 130 may continuously determine whether a user is positioned in front of the display apparatus 100 and the user position state at specific cycle. In this case, output mode to be entered based on the user context and priority ranking of the information to be provided in each output mode (e.g., provided widgets, priority ranking of applications, etc.) may be determined.

For example, the processor 130 may turn on the display apparatus 100 when a user is sensed within a first certain distance (e.g., 2 m) through the sensor 120 in the fourth mode, and prepare for entering the first mode. When a user is sensed within a second certain distance (e.g., 1 m), the processor 130 may enter the first mode and output the information-providing content.

The fifth mode is a mode for providing the alarm function corresponding to the alarm set in the display apparatus 100 or an external user terminal. In the fifth mode, an image corresponding to an alarm description, an alarm time, current weather, and so on may be automatically played with an alarm sound (or alarm music). For example, along with a morning wake-up alarm, an image encouraging a user to do some stretching may be automatically played. In this case, the user may be encouraged to do morning exercises by looking at the mirror which may display a layout of movements in dotted lines or provide a stretching-related image. Further, in case of an anniversary notice, a background image suitable for the special day may be provided (e.g., a cake image in case of a birthday). In some examples, some images may represent flash feedback with an instant brightness change, and such feedback may be synchronized with corresponding alarm sound.

Further, when the display apparatus 100 is synchronized with a sleep sensing device (e.g., sleepsense), an optimized wake-up time based on the user sleep state may be provided. Additionally, corresponding time may be automatically calculated based on information with respect to the received sleep state of a user from the sleep sensing device, and the alarm function may be provided accordingly.

Meanwhile, the processor 130 may drive in the fifth mode according to time corresponding to set alarm information, and may control to automatically enter the first mode when the fifth mode is completed. For example, when it is determined there is no other intention (user intention not to use the display apparatus 100 as a mirror) after the alarm according to the fifth mode is provided, the processor 130 may enter the first mode.

According to an exemplary embodiment, the sensor 120 for sensing a user may perform duration of sensing the user by maintaining the first to fifth modes described above in the active state.

Meanwhile, the processor 130 may determine the user's intention of using the display 110 based on at least one of the user current position, the user position change, the user approaching speed, and the user action, which are sensed by the sensor 120.

Additionally, the processor 130 may determine the user's intention of using the display 110 based on a remote controller signal received from a remote controller, a history of a remote controller, an external temperature based on the user position, an ambient temperature, a user action (e.g., eye make-up, hair styling, etc.), time, date, date-related information (e.g., holiday, public holiday, weekdays, weekends, specific day, date associated with acquainted people, etc.), a duration of using the device, a duration of user's being in a position, schedule inputted through another device by a user, an alarm, a reminder, a user related data received from the other sensing device, whether or not being present at a network access point such as another device, and so on. However, even when the intention of use is not determined, it is of course possible that a mode corresponding to the sensed data may still be provided based on the sensed data and previously-stored mode information mapped with the sensed data. The following will be described by assuming that the user's intention of use is determined for convenient explanation.

Specifically, the processor 130 may control the operation to be performed in the first mode when the user approaching speed sensed by the sensor 120 is less than a preset threshold speed, and control the operation to be performed in the second mode or the third mode when the sensed user approaching speed is a preset threshold speed or higher. This is to reflect the behavior of the user who would generally fast approach the mirror when he or she intends to see the mirror or do a specific interaction.

Specifically, the processor 130 may determine that the user has an intention of using the display 110 as a mirror when: the sensor 120 senses a user, i.e., senses the user moving within a preset distance to the display 110 with a preset threshold speed or above; the sensor 120 senses a user gradually moving forward to the display apparatus 100 with a preset threshold speed or above; and so on. Note that, in one example, the processor 130 may provide additional functions (e.g., UI screen) together when a user action corresponding to another intention (e.g., remote controller manipulation, manipulation on buttons provided on the display apparatus 100, and so on) is additionally sensed.

Further, when at least one of a duration of sensing the user by the sensor 120 and a duration of using the display 110 is less than a preset threshold time, the processor 130 may control the operation to be performed in the first mode. When at least one of a duration of sensing the user and a duration of using the display 110 is equal to, or greater than the preset threshold time, the processor 130 may control the operation to be performed in the second or third mode.

Specifically, when the user approaching speed is sensed to be equal to, or greater than a preset threshold speed, and at the same time, when a user maintains at a preset threshold distance or greater and for a preset threshold time or longer, the processor 130 may determine an intention of using the display 110 as a mirror. However, because a distance from the mirror may vary depending on the user's intention such as an intention to look closer at the mirror or look farther away from the mirror, the threshold preset distance may be changed.

Further, when communication is connected with an external user terminal and information related with applications is received from the external user terminal, the processor 130 may automatically operate in the third mode and provide the application information received from the external user terminal. However, when communication is connected with the external user terminal but no information is received from the external user terminal, the processor 130 may operate automatically in the first mode or the second mode.

Further, when determining that the user intention is to use the display 110 as a mirror, the processor 130 may adjust at least one of ON/OFF state and intensity of the light based on the sensed ambient illumination by the sensor 120. For example, when the ambient illumination is too lower for viewing a mirror, illumination suitable for mirror viewing may be provided to provide suitable lighting.

Meanwhile, the processor 130 may maintain current state when a user is present in a dead zone of the sensor 120. For example, while operating in the second mode of sensing for a user approach to the display apparatus 100, the processor 130 may maintain a mirror state when the user is not sensed suddenly.

Further, based on the user context information, the processor 130 may express background colors of the display 100 in different colors according to time zone, or output different images. For example, a constellation image may be provided as background image at a sleep time of a user.

Further, when booting is performed with a user button manipulation of a user or a remote controller signal in the fourth mode, immediately upon booting, as the user sensor state is first driven and determines that the user is standing in front, the processor 130 may change the mode to be suitable for the intention determined according to the user context.

Further, the processor 130 may provide user-interactable UI button in a form of a lighted button on a position proximate to the screen. The light may emit a light only in the second mode or the third mode. For example, the processor 130 may provide a feedback of gradually turning on the light upon entering a corresponding mode.

Further, the processor 130 may adjust brightness intensity of the display 110 according to the user context. For example, the processor 130 may provide an eyesight protecting function by adjusting the light intensity (e.g., backlight optical intensity adjustment and panel supply electric current amount control) based on the approaching distance of a user, ambient illumination, and so on.

Further, when a user moving direction is sensed by the sensor 120, the processor 130 may move the display position of content based on the user moving direction.

Further, the processor 130 may automatically rotate the screen according to a user viewing direction.

Further, the processor 130 may tilt the display 110 according to a user movement (e.g., moving direction). For example, the processor 130 may sense a user moving direction through the pin hole sensor and tilt the display 110 by using a motor.

Further, the processor 130 may power-on the display apparatus 100 when a user does not move in front of the display apparatus 100 a certain time after being sensed, and power-off the display apparatus 100 when a user is out of a sensing angle range of the sensor for a certain time.

Further, after sensing a user distance, the processor 130 may determine a user's physique and automatically recommend content. For example, upon determining a user to be a child, the processor 130 may automatically display a cartoon or a child program. When a user is determined to be a pet, the processor 130 may automatically display a pet program.

Further, following sensing a user distance, the processor 130 may then determine a user's physique and automatically block harmful channels and sites for a specific user.

Further, the processor 130 may support a health care function such as providing body size change information and providing a posture correcting method.

Further, the processor 130 may provide a function with which a user virtually performs make-up or tries on clothes on a reflected image of a user on the mirror, or may recommend clothes or make-up suitable for corresponding schedule/weather or items such as umbrella/rubber boots.

Further, the processor 130 may recognize a gesture of receiving a phone call or a specific word during viewing and automatically perform a function of muting or turning down a volume.

Further, the processor 130 may sense a distance between a user and the display apparatus 100 and adjust a size of subtitle and a volume of sounds.

Further, the processor 130 may also be connected with a home network system and control the state of the sensor 120. For example, the processor 130 may sense whether a main door is opened externally or internally with a door lock, and turn off the display apparatus 100 and the sensor 120 when the main door is opened internally, and turn on the sensor 120 when the main door is opened externally.

Further, the processor 130 may run a skin diagnosis application of the user terminal 200 on a regular basis and store the results of the skin diagnosis and thus provide a tutorial regarding a management method according to changes.

Meanwhile, according to an exemplary embodiment, the user terminal such as a mobile phone may be used as a remote control device. For example, a mobile phone may be triggered to have a remote control function for the display apparatus 100 through contacts, near field communication, and so on with the display apparatus 100. For another example, the mobile phone may be automatically triggered to have the remote control function for the display apparatus 100 based on at least one of the user position, time, and content use information. For another example, when the mode is converted, a button that can be used in the mobile phone (e.g., button that can be touched) may be automatically modified so as to correspond to the converted mode.

Depending on circumstances, upon entering a specific mode (e.g., third mode), the processor 130 may automatically connect a communication with a source device that provides content available to be outputted in the entered mode. For example, the processor 130 may automatically connect to the source device that provides the information-providing content in the first mode, automatically connect to the source device that provides the widget content in the second mode, and automatically connect to the source device that provides the application content in the third mode. Herein, ‘connect a communication’ may indicate all the states in which communication is enabled, such as, operation of initializing communication between the display apparatus 100 and the source device, operation of forming a network, operation of performing a device pairing, and so on. For example, device identification information of the display apparatus 100 may be provided to the source device, thus initiating a pairing process between the two devices. For example, when a preset event occurs in the display apparatus 100, surrounding devices may be searched through the digital living network alliance (DLNA) technology, and interoperation state may be implemented by a pairing performed with the source device corresponding to a determined mode.

In this case, the processor 130 may display a list of contents that can be provided in the connected source device. For example, when the external user terminal (or external server) is connected according to the initiation of the third mode, a list of applications that can be provided from the external user terminal (or external server) may be displayed. However, when a previously-stored content is provided, a list of the previously-stored contents corresponding to each mode may be automatically displayed.

When the mode is determined according to the event, the processor 130 may local-dim at least a certain region of the screen of the display 110 based on characteristics of the determined mode. For example, when the mirror region is exclusively provided on a certain region of the screen in the second mode, the region other than the corresponding screen region may be local-dimmed and the power consumption may be reduced.

When the mode is determined according to the event, the processor 130 may control such that an optimum output mode in which corresponding content may be viewed/listened based on the properties of the content provided in the determined mode. For example, when an audio signal is included in the information-providing content displayed in the first mode, the processor 130 may activate at least one speaker, and adjust automatically a sound output volume correspondingly to the determined mode. For example, a speaker and a sound output volume suitable for each mode may be set.

For another example, when the mode is determined according to the event, the processor 130 may adjust output brightness of pixels based on the properties of the determined mode. For example, pixel brightness may decrease in the first and second modes and increase in the third mode. Alternatively, the output mode may be converted into a low power mode in which pixel brightness automatically decreases in the first and second modes.

The processor 130 may provide a preset feedback when the mode is converted. For example, at least one of a visual feedback for providing preset image and an auditory feedback for providing a preset sound may be provided. In this case, different forms of feedbacks related with the properties of the converted mode may be provided. For example, upon converting from a specific mode into the second mode, a feedback may be provided, providing a visual effect of glittering when converting from a specific mode into the second mode.

Meanwhile, in the first mode, the processor 130 may connect a communication to an external source (e.g., external server) that automatically provides the information-providing content and receive the information-providing content, or display the previously-stored information-providing content in the display apparatus 100 on the screen of the display 110. Herein, ‘receiving the information-providing content from an external source and displaying the same’ may include a configuration of receiving the content played in the external source (e.g., external server) in a form of streams and displaying the same, as well as a configuration of downloading the content from the external source and displaying the same with the processor 130. In this case, when a resolution of the information-providing content downloaded or received in a form of streams is different from a resolution of the display 110, the processor 130 may convert the format into a proper resolution before displaying the same.

When the image content is received from the external source, the processor 130 may transmit information such as resolution of the image content that can be processed in the image sound apparatus 100, performance of the decoder and types of codecs installed in the image sound apparatus 100 to the external source, and receive the image content with a correspondingly converted format from the external source. Further, the processor 130 may convert the image content received from the external source into a form that can be outputted in the image sound apparatus 100 and display the same.

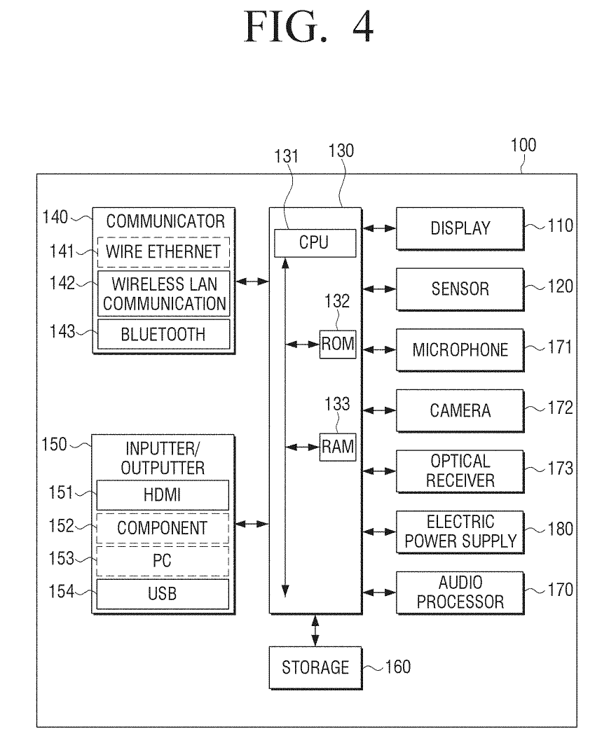

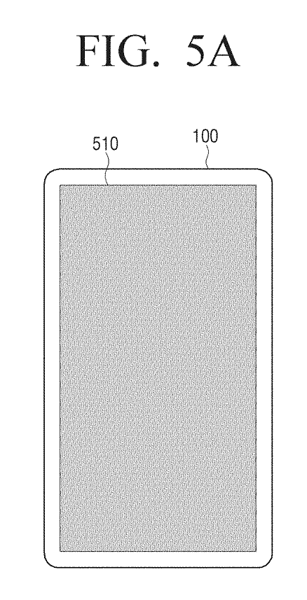

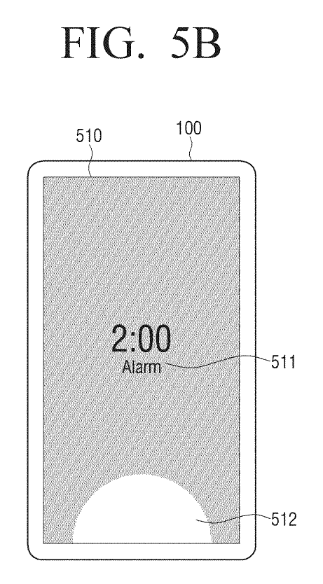

FIG. 4 is a block diagram illustrating a detailed configuration of the display apparatus illustrated in FIG. 2.

Referring to FIG. 4, the image sound apparatus 100 may include the display 110, the sensor 120, the processor 130, a communicator 140, inputter/outputter 150, a storage 160 (e.g., memory), an audio processor 170, a power supply 180, a microphone 171, a camera 172, and an light receiver 173. The elements illustrated in FIG. 4 overlapping with the elements illustrated in FIG. 2 will not be explained below.

The processor 130 may include CPU 131, ROM 132 (or non-volatile memory) storing a control program for controlling of an image sound system 1000 including the display apparatus 100, and RAM 133 (or volatile memory) storing data inputted externally from the display apparatus 100 or used as storing region corresponding to various tasks performed in the image sound apparatus 100.

The processor 130 may control the overall operation of the display apparatus 100 and a signal flow between the internal elements 110 to 193 of the image sound apparatus 100, and performs a function of processing the data. However, depending on circumstances, a first processor for processing the user sensing data, and a second processor for controlling a display output state, may be separately included.

The processor 130 may control the power supply from a power supply 290 to the internal elements 110-193. Further, the processor 130 may implement the Operating System (OS) stored in the storage 160 and various applications when a preset event occurs.

The processor 130 may include a graphic processing unit for graphic processing corresponding to the image. The processor 130 may be implemented to be system on chip (SoC) including a core and GPU. The processor 130 may include a single core, a dual core, a triple core, a quad core, and a multiple number of cores.

The CPU 131 may access the storage 160 and perform the booting by using the 0/S stored in the storage 160. Further, various operations may be performed by using the various programs, contents and data stored in the storage 160.

The ROM 132 may store a set of instructions for system booting. When a turn-on command is inputted and the power is supplied, the CPU 131 may copy the 0/S stored in the storage 160 onto the RAM 133 according to the instructions stored in the ROM 132, and boot the system by implementing 0/S. When the booting is completed, the CPU 131 may copy the various programs stored in the storage 160 onto the RAM 133, and perform various operations by implementing the programs copied onto RAM 133. Herein, the CPU 131, the ROM 132, and the RAM 133 may be connected to each other through an internal bus.

Meanwhile, the display apparatus 100 may be connected to the external device by wire or wirelessly, by using the communicator 140 or the inputter/outputter 150. The external device may include a mobile phone, a smart phone, a tablet PC, a server, and so on.

The communicator 140 may connect the display apparatus 100 to an external device under the controlling of the processor 130. The processor 130 may download, or receive content in a form of streams externally through the communicator 140. Specifically, when the mode is determined according to the event, the processor 130 may control the communicator 140 to automatically connect communication with the source device that provides the content available to be outputted in the determined mode.

The communicator 140 may include at least one of a wired Ethernet 141, a wireless LAN communicator 142, and a near field communicator 143 (e.g., Bluetooth), according to performance and configuration of the display apparatus 100.

The inputter/outputter 150 may receive various contents from an external source under the controlling of the processor 130. For example, the content may include at least one of video, image, text, and sound. The inputter/outputter 150 may include at least one of a high-definition multimedia interface (HDMI) port 151, a component input jack 152, a PC input port 153 and a USB input jack 154.

The storage 160 may store various data, programs or applications for driving/controlling the display apparatus 100.

The storage 160 may store control programs for controlling the display apparatus 100 and the processor 130, applications provided initially from a manufacturer or downloaded externally, a graphical user interface (GUI) related with applications, objects providing GUI (e.g., image texts, icons, buttons, etc.), user information, documents, database or relevant data.

The storage 160 may include a user sensing module, a communication control module, a voice recognizing module, a motion recognizing module, an optical receiving module, a display control module, an audio control module, an external input control module, a power control module, a voice database (DB) or a motion database (DB). The processor 130 may perform a function of the display apparatus 100 by using the software stored in the storage 160.

The storage 160 may include a memory card (e.g., micro SD card, USB memory, etc.) mounted to the display apparatus 100, an external memory (e.g., USB memory, etc.) that can be connected to the USB port 154 of the inputter/outputter 150, a non-volatile memory, a volatile memory, a hard disc drive (HDD) or a solid state drive (SSD).

The microphone 171 is configured to receive user voices or other sounds and convert these into audio data. The camera 172 is configured to photograph still images or videos under the controlling of a user. The processor 130 may use the user voices inputted through the microphone 171 during a call, or convert these into audio data and store the audio data in the storage 160. When the microphone 171 and the camera 172 are provided, the processor 130 may perform various control operations such as selecting the first to third modes according to the user voices inputted through the microphone 171 or the user motion recognized by the camera 172.

The light receiver 173 may receive an optical signal (including control information) outputted from a remote-control apparatus through a light window.

The light receiver 173 may receive an optical signal corresponding to user input (e.g., touch, press, touch gesture, voice or motion) from the remote-control apparatus. In this case, the control information extracted from the received optical signal may be transmitted to the processor 130.

The power supply 180 may provide the power inputted from an external power source to the internal elements 110-180 of the display apparatus 100 under the controlling of the processor 130.

Meanwhile, when the display apparatus 100 is implemented to be TV, a tuner may be further included. In the broadcasting signals received by wire or wirelessly, the tuner may tune and select only a frequency of a channel intended to be received by the image sound apparatus 100 from various electromagnetic wave components through amplification, mixing, resonance, and so on. For example, the tuner may tune and provide the broadcasting channel as selected by the user in the third mode.

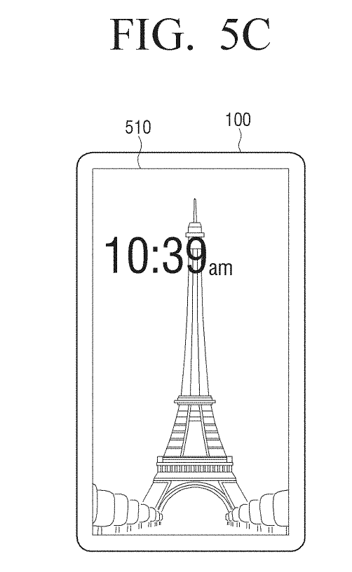

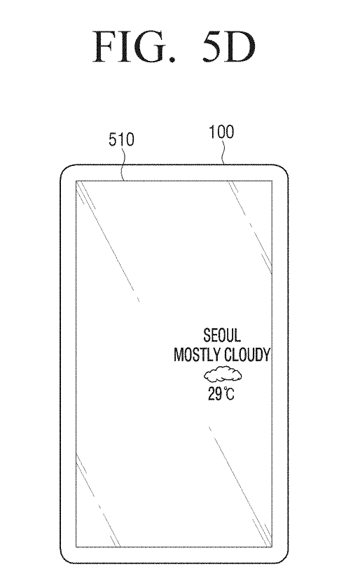

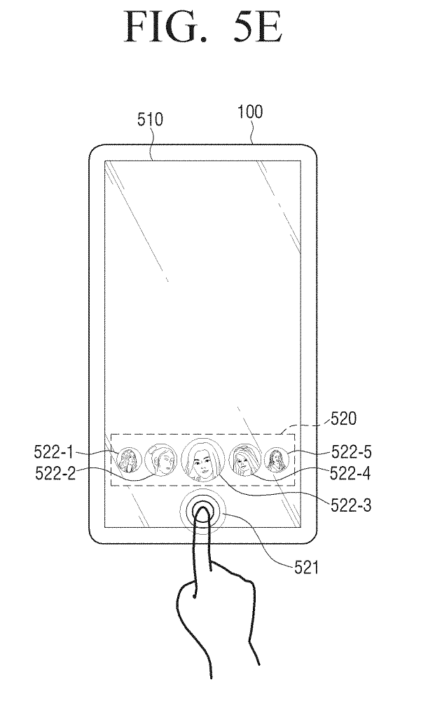

FIGS. 5A to 5E are diagrams illustrating display output state according to one or more exemplary embodiments.

FIG. 5A illustrates screen output state in the fourth mode according to an exemplary embodiment, in which, in the fourth mode, operation may be performed in the maximum power saving state, and the screen 510 may be in off-state as illustrated.

FIG. 5B illustrates screen output state in the fifth mode according to an exemplary embodiment, in which, in the fifth mode, a notice screen corresponding to the alarm set in the display apparatus 100 or the external user terminal may be provided. For example, on the screen 510, both the time information set with the alarm 511 and the visual feedback 512 (e.g., flash feedback) may be provided together, as illustrated.

FIG. 5C illustrates screen output state in the first mode according to an exemplary embodiment. In the first mode, the display 110 may operate to perform a normal display function, and as illustrated, the information-providing content may be outputted on the screen 510. For example, various types of information-providing contents, such as, advertisement content, news content, guide content, and so on, may be outputted on the screen.

FIG. 5D illustrates screen output state in the second mode according to an exemplary embodiment. In the second mode, the display 110 may operate to perform the mirror function, and a mirror may be provided on the screen 510. As illustrated, passive forms of information such as widgets and guide information may be provided on a certain region of the screen 510. However, information may not be displayed depending on circumstances.

FIG. 5E illustrates screen output state in the third mode according to an exemplary embodiment. In the third mode, the mirror function may be performed likewise in the second mode, and a mirror may be provided on the screen 510. In the third mode, UI screen 520 in which user interaction is possibly performed may be provided on at least one region in the third mode. Herein, UI screen 520 may include applications 522-1-522-5 that are driven as selected by the user. Various UIs 521 receiving inputting of a user command may be provided. Although FIG. 5E illustrates that the mirror function may also be provided in the third mode, this is merely an example. Accordingly, the mirror function may be selectively activated or inactivated.

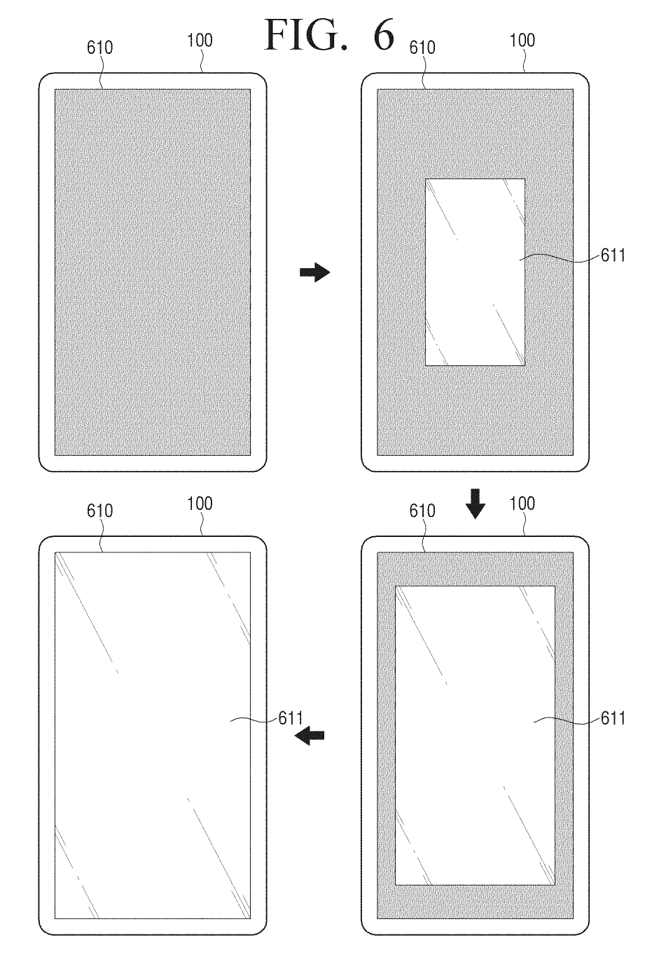

FIG. 6 is a diagram illustrating screen output state in the second mode according to an exemplary embodiment.

More specifically, FIG. 6 is a diagram illustrating screen output state when the second mode is entered from another mode (e.g., fourth mode) according to an exemplary embodiment.

As illustrated in FIG. 6, a size of a region that provides the mirror function on the screen 610 may be modified according to an event. For example, when a user gradually approaches the display apparatus 100 while meeting conditions for providing the second mode, a size of the region 611 that provides the mirror function may be gradually magnified. Further, a speed of modifying a size of the region 611 providing the mirror function may be determined based on a user approaching speed.

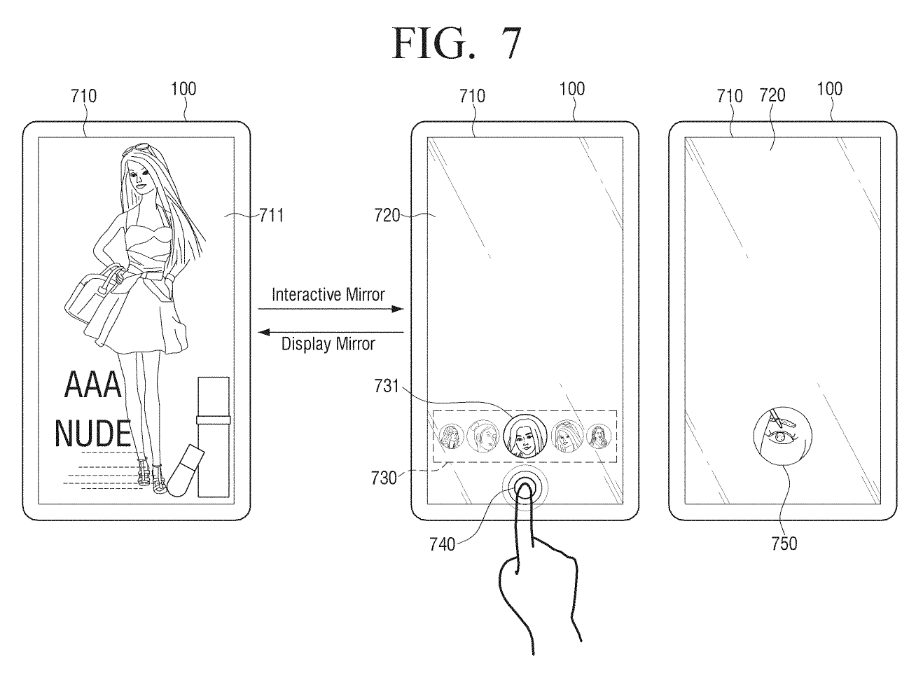

FIG. 7 is a diagram illustrating screen output state in the third mode according to an exemplary embodiment.

A leftmost drawing of FIG. 7 illustrates output state in the first mode, in which the information-providing content 711 may be displayed on the screen 710, as illustrated. For example, as illustrated, the information-providing content such as advertisement content or info content (e.g., widget-providing information such as weather, building guide information, etc.) may be displayed.

Thereafter, the third mode may be entered according to preset event, and in the third mode, UI screen that can be selected by a user may be provided. For example, when tutorial information is provided in the third mode, an interactive mirror 720, a video widget screen 730 and a select GUI 740, in which browsing can be performed through a scroll, may be provided as illustrated in a center. Next, when one video widget 731 is selected, detail information 750 corresponding to the selected video widget 731 may be played through the video player as illustrated in a rightmost drawing. However, only partial and main information 750 may be provided instead of a whole screen of the image, with the interactive mirror 720 on the screen, as illustrated.

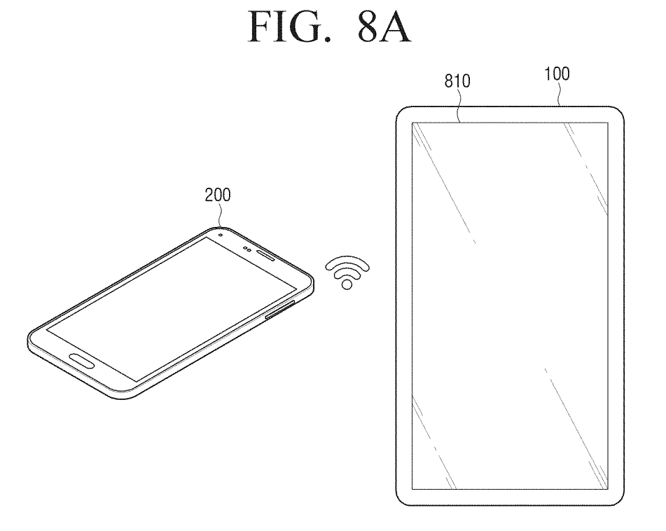

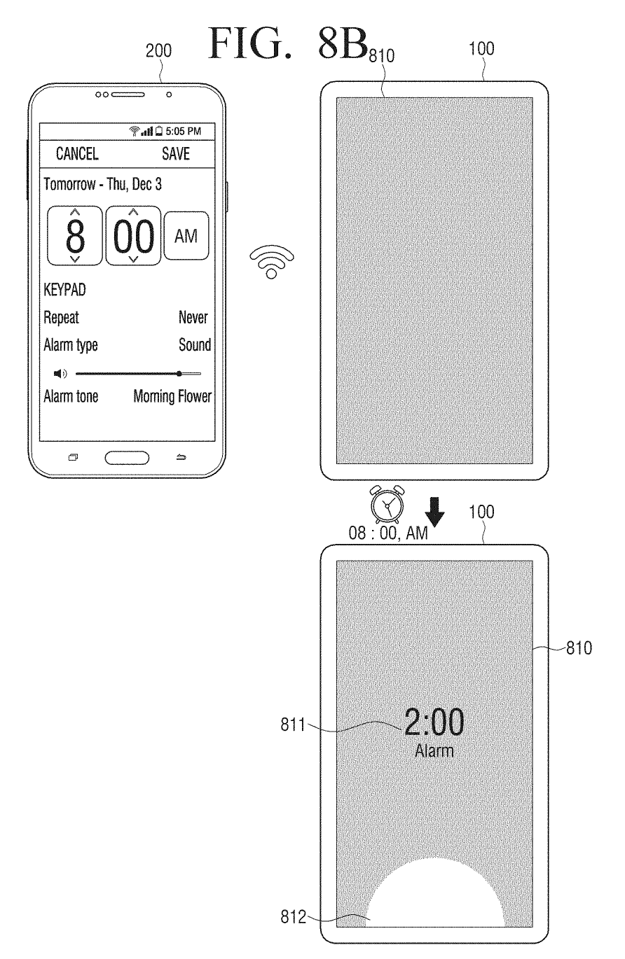

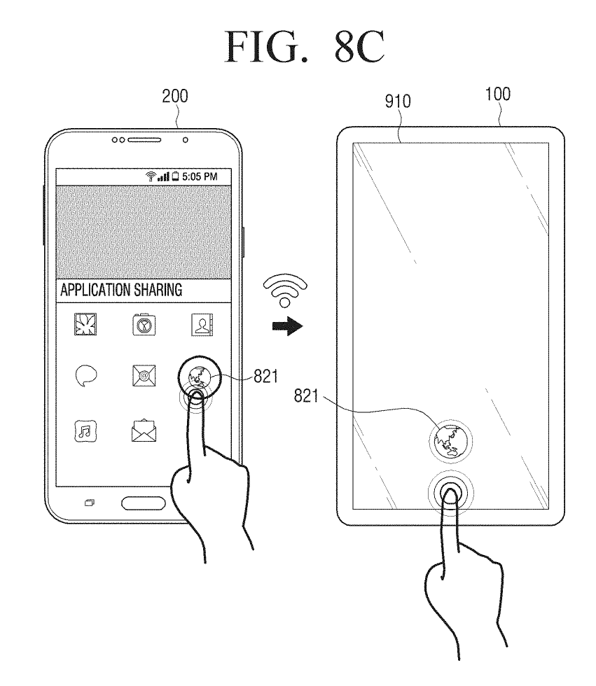

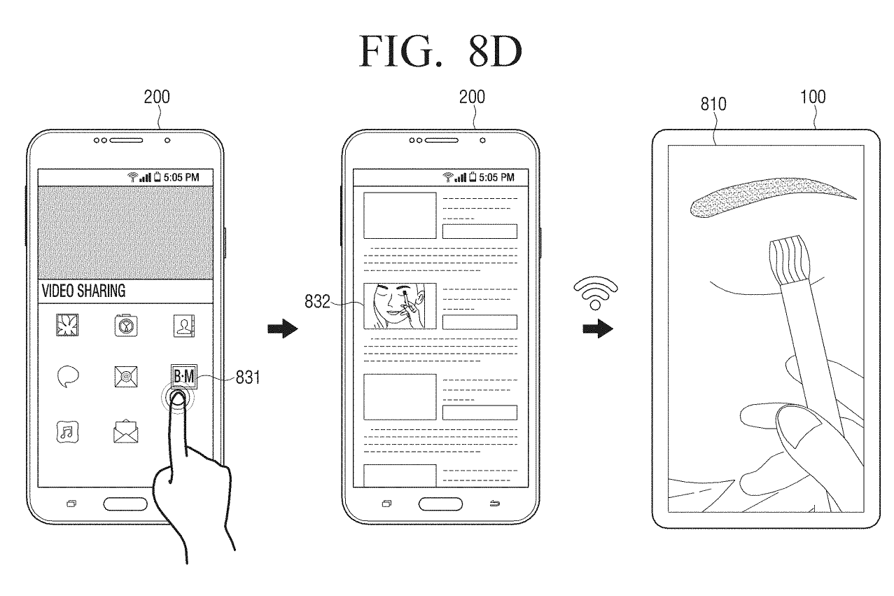

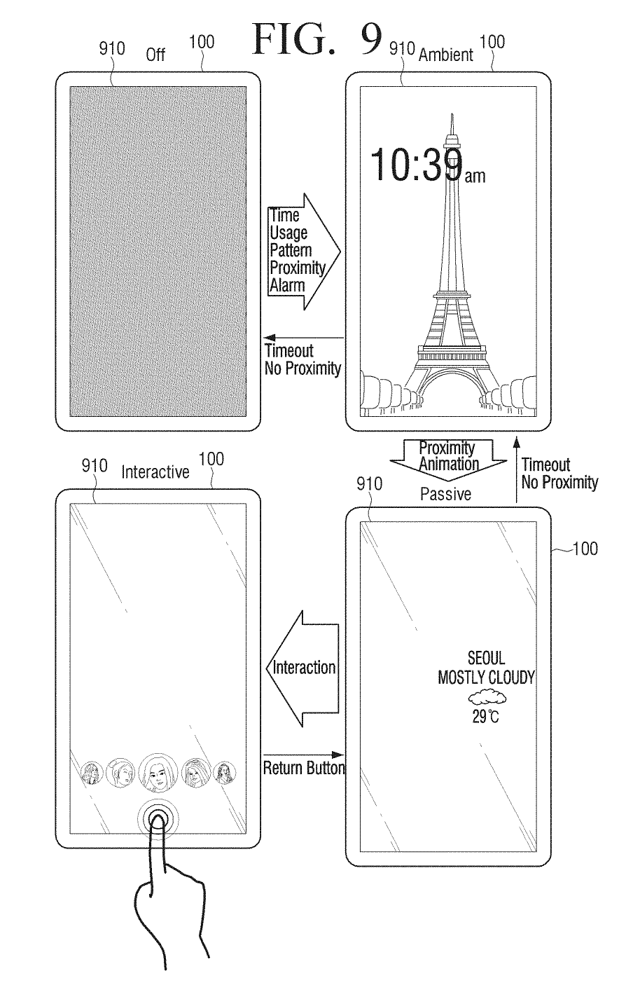

FIGS. 8A to 8D are diagrams illustrating screen output state according to an exemplary embodiment.

As illustrated in FIG. 8A, although communication is connected between the display apparatus 100 and the user terminal 200, in the absence of user interaction in the display apparatus 100 or the user terminal 200, the display screen 810 may provide the mirror function. This is performed because the processor 130 determines that a user approaches the display apparatus 100 to use it simply as a mirror when there is no user interaction.

As illustrated in FIG. 8B, when communication is connected between the display apparatus 100 and the user terminal 200, and the alarm time set through the user terminal 200 approaches, the display apparatus 100 may operate in the fifth mode. In this case, the alarm information 811 and a preset feedback 812 may be provided on the screen 810.

As illustrated in FIG. 8C, when communication is connected between the display apparatus 100 and the user terminal 200, and an application 821 is selected on the user terminal 200, the corresponding application 821 may be provided to the display apparatus 100, and the display apparatus 100 may operate in the second mode or the third mode. In this case, corresponding application may be transmitted and provided to the display apparatus 100, although the screen of the user terminal 200 may be simply mirrored on the screen 910 of the display apparatus 100.

As illustrated in FIG. 8D, when communication is connected between the display apparatus 100 and the user terminal 200, an application 831 of the user terminal 200 is driven, and an image 832 within corresponding application 831 is selected, and a corresponding image 832 may be played in the screen 810 of the display apparatus 100.

FIG. 9 is a diagram illustrating a mode change process according to an exemplary embodiment.

Referring to FIG. 9, the first mode may be entered according to first event from the fourth mode in which the screen 910 of the display apparatus 100 is off, the second mode may be entered according to second event from the first mode, and the third mode may be entered according to third event from the second mode. Exemplary embodiments corresponding to the first to third event are described above.

Thereafter, in response to input of a return button in the third mode, the third mode may be converted into the second mode. When user non-approaching state is maintained for a preset time or longer in the second mode, the operation may enter the first mode. Further, when user non-sensing state is maintained for a preset time or longer in the first mode, the operation may enter the fourth mode.

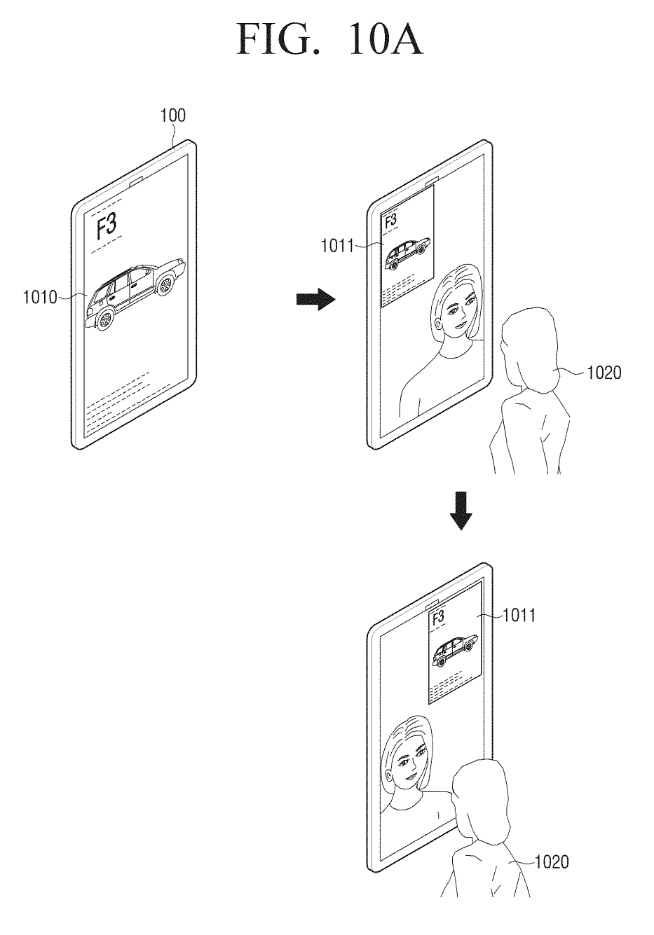

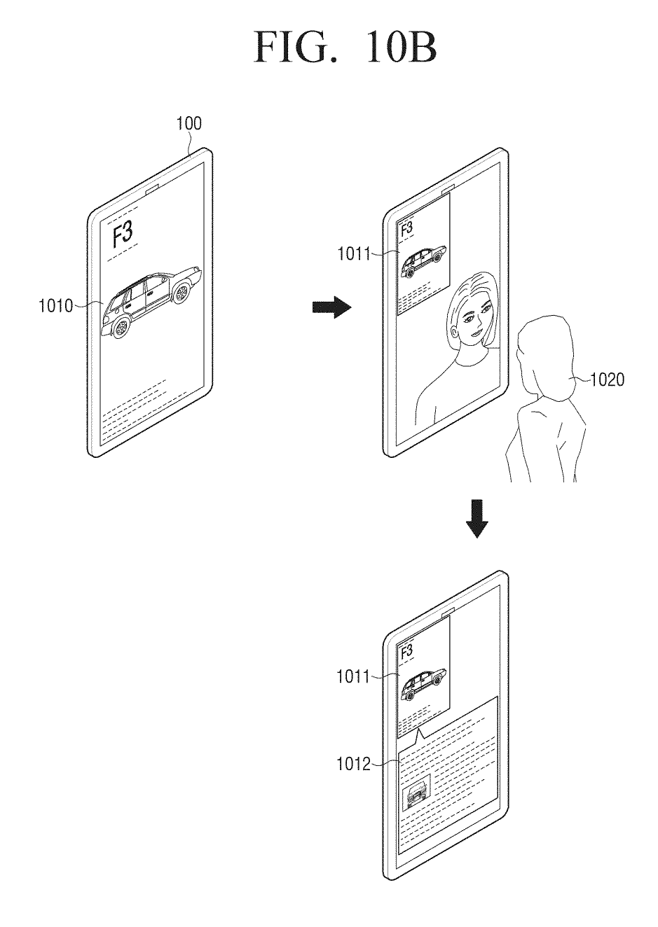

FIGS. 10A and 10B are diagram illustrating a method for providing content according to an exemplary embodiment.

Referring to FIGS. 10A and 10B, size and position of the content displayed on the screen 1010 may be adjusted based on position and distance of a user 1020.

As illustrated in FIG. 10A, when a user 1020 is not detected, the display apparatus 100 may display content on the screen 1010. Next, as illustrated in FIGS. 10B and 10C, when a distance between the display apparatus 100 and a user 1020 decreases, the display apparatus 100 may reduce a size of the content 1011 displayed on the screen 1010 and display the result, and change a position of the content 1011 based on a position of a user 1020. Therefore, a user may easily determine the content displayed on the screen while freely modifying a position in front of a mirror. Illustrated at a lower portion of FIG. 10B, a user may receive more information 1012 about content 1011.

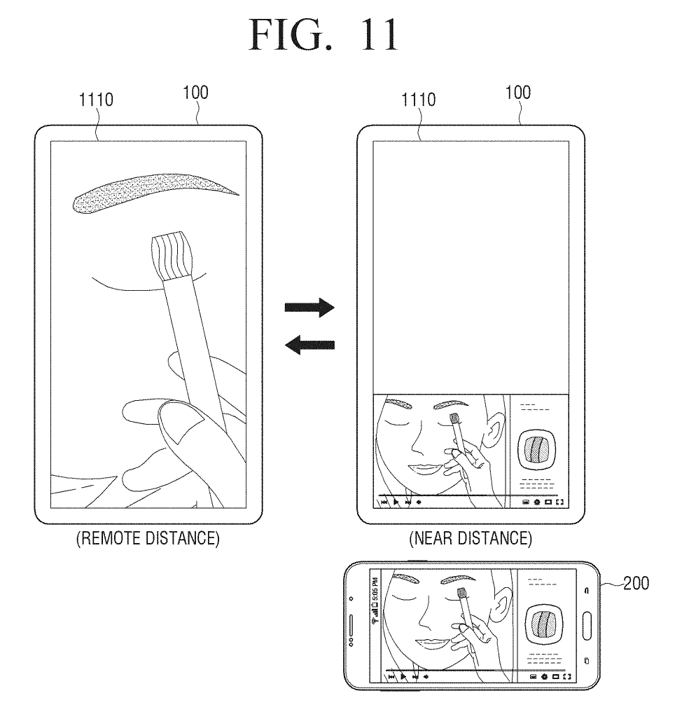

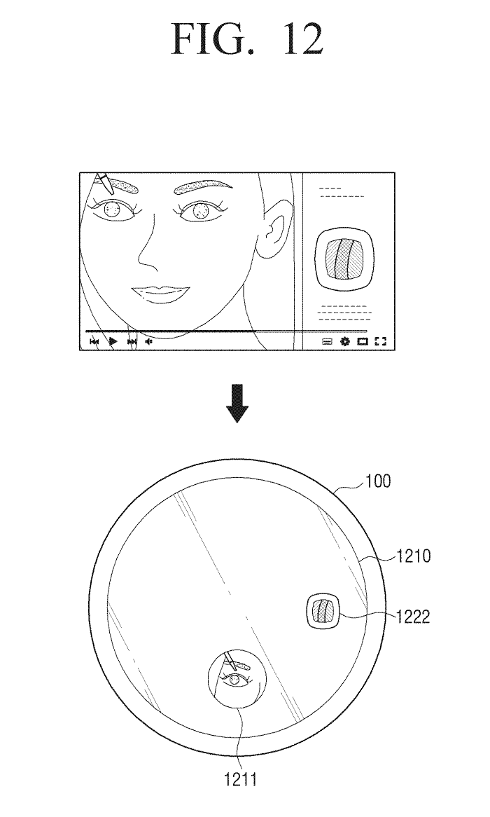

FIGS. 11 and 12 are diagrams illustrating a method for providing mirroring content according to an exemplary embodiment.

Referring to FIG. 11, when communication is connected between the display apparatus 100 and the user terminal 200, and the image displayed on the user terminal 200 is mirrored on the screen 1110 of the display apparatus 100, the mirroring screen may be provided in different methods based on a user approaching distance. For example, as illustrated, when a user is present at a remote distance, a main content region of the image played on the user terminal 200 may be magnified and provided on the screen 1110. Further, when a user is present at a near distance, the image may be mirrored and provided as is. The mirroring image provided on the screen 1110 may be gradually magnified or reduced to restore into the original image based on a user approaching distance.

Referring to FIG. 12, when the image played on the user terminal 200 is mirrored on the screen 1210 of the display apparatus 100, instead of directly displaying the played image, only the main content regions 1211, 1222 may be provided on the screen 1210, and the mirror function may be provided on the other regions.

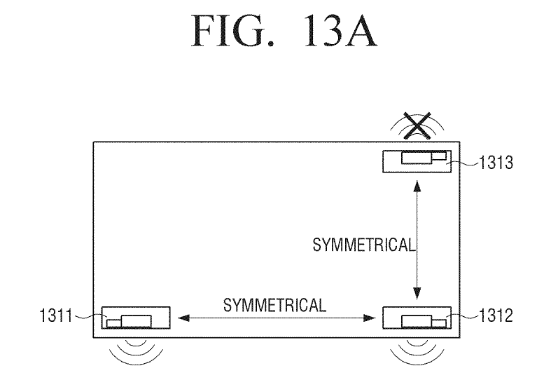

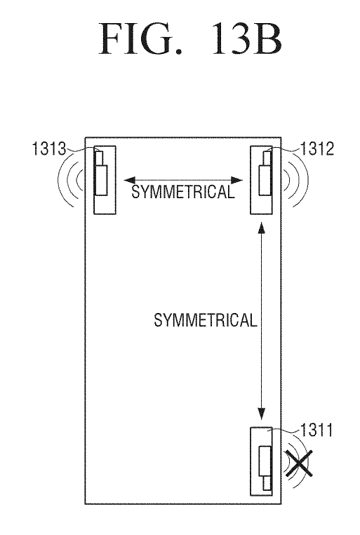

FIGS. 13A and 13B are diagrams illustrating a method for controlling a speaker according to an exemplary embodiment.

According to an exemplary embodiment, playing state of a plurality of the speakers included in the display apparatus 100 may be controlled based on a rotating direction of the display apparatus 100.

As illustrated in FIGS. 13A and 13B, when the three speakers 1311, 1312, 1313 are provided on three edge regions of the display apparatus 100, one speaker may be muted and only the two speakers may be used based on a rotation direction of the display apparatus 100 (e.g., as sensed with the acceleration sensor). For example, the first and third speakers 1311, 1313 may output a left sound, the second speaker 1312 may output a right sound, such outputting may be maintained even when the display apparatus 100 rotates, and the third speaker 1313 may be muted when the display apparatus 100 is directed horizontally, and the first speaker 1311 may be muted when the display apparatus 100 rotates to a vertical direction.

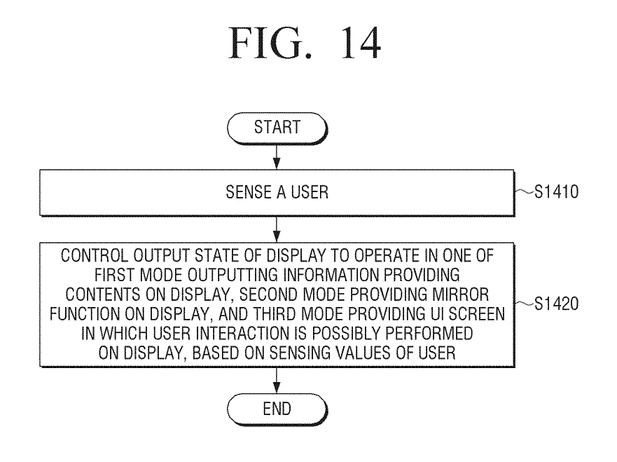

FIG. 14 is a flowchart illustrating a control method of the display apparatus according to an exemplary embodiment.

According to the control method of the display apparatus in FIG. 14, a user may be sensed at S1410. Display output state may be controlled so as to operate in one of the first mode for outputting information-providing content on the display, the second mode for providing the mirror function on the display, and the third mode for providing UI screen in which user interaction is possibly performed, based on user sensing values, at S1420.

Herein, the second mode is a mode for providing passive content on a certain region of the display and providing the mirror function on the other region, and the third mode is a mode for providing UI screen including active content on a certain region of the display and providing the mirror function on the other region.

Further, at S1410 of sensing a user, a user approaching speed may be sensed. In this case, at S1420 of controlling output state of the display, operation may be performed in the first mode when the sensed approaching speed is less than a preset threshold speed, and operation may be performed in the second mode or the third mode when the sensed approaching speed is equal to, or greater than a preset threshold speed.

Further, at S1420 of controlling output state of the display, when at least one of a duration of sensing the user and a duration of using the display is less than a preset threshold time, controlling may be performed so as to operate in the first mode. When at least one of a duration of sensing the user and a duration of using the display is equal to, or greater than a preset threshold time, controlling may be performed so as to operate in the second mode or the third mode.

Further, at S1410 sensing a user, at least one among a user current position, a user position change, a user approaching speed, a user action, a duration of sensing the user, and a duration of using the display may be sensed.

Further, the control method according to an exemplary embodiment may include a process of sensing ambient illumination and a process of adjusting at least one among ON/OFF and intensity of a light based on the sensed ambient illumination in the second mode or the third mode.

Further, the control method according to an exemplary embodiment may include a process of providing the mirror function on at least a certain region of the display based on the user approaching distance in the second mode, and adjusting a size of at least one partial region of the display as the user approaching distance is modified.

Further, the control method according to an exemplary embodiment may include a process of operating in the fourth mode for providing an alarm based on the received alarm information from the external user terminal and operating in the first mode automatically when the fourth mode is completed.

Further, the control method according to an exemplary embodiment may include a process of controlling operation to be performed in the second mode or the third mode based on user command input state in the external user terminal when communication is connected with the external user terminal.

Meanwhile, the methods according to the above one or more exemplary embodiments may be implemented only with software/hardware upgrading regarding a related display apparatus.

Further, the above one or more exemplary embodiments may be performed through an embedded server provided on the display apparatus or an external server of the image sound apparatus.

Further, there may be provided non-transitory computer readable recording medium storing programs performing the control method according to an exemplary embodiment sequentially.

The ‘non-transitory computer readable recording medium’ as used herein may indicate a medium which stores data semi-permanently and can be read by devices, rather than a medium storing data temporarily such as register, cache, or memory. Specifically, the above various applications or programs may be stored and provided in non-transitory computer readable recording medium such as CD, DVD, hard disk, Blu-ray disk, USB, memory card, or ROM.

The above-described exemplary embodiments are merely exemplary and are not to be construed as limiting. The present teaching can be readily applied to other types of apparatuses. Also, the above description of exemplary embodiments is intended to be illustrative, and not to limit the scope of the claims.

What is claimed is:

1. A display apparatus, comprising:
a display;
a sensor configured to sense a user; and
a processor configured to control, based on sensed values of the user, the display to operate in one mode from among a first mode, a second mode, and a third mode,
wherein the first mode comprises outputting information-providing content on the display, the second mode comprises providing a mirror function on the display, and the third mode comprises providing a user interface (UI) screen in which user interaction is performed.

2. The display apparatus of claim 1, wherein the second mode further comprises providing passive content on a region of the display and providing the mirror function on another region of the display, and
the third mode comprises providing the UI screen comprising active content on a region of the display and providing the mirror function on another region of the display.

3. The display apparatus of claim 1, wherein the sensor is further configured to sense an approaching speed of the user, and
the processor is further configured to, control the display to operate in the first mode when the sensed approaching speed is less than a preset threshold speed, and control the display to operate in the second mode or the third mode when the sensed approaching speed is greater than or equal to the preset threshold speed.

4. The display apparatus of claim 3, wherein the processor is further configured to control the display to operate in the first mode when at least one of a duration of sensing the user and a duration of using the display is less than a preset threshold time, and control the display to operate in the second mode or the third mode when at least one of the duration of sensing the user and the duration of using the display is greater than or equal to the preset threshold time.

5. The display apparatus of claim 1, wherein the sensor is further configured to sense values of at least one from among a current position of the user, a position change of the user, an approaching speed of the user, an action of the user, a duration of sensing the user and a duration of using the display, and
the processor is further configured to c control the display to operate in one of the first to third modes based on the sensed values from the sensor.

6. The display apparatus of claim 5, wherein the sensor is further configured to additionally sense ambient illumination, and
the processor is further configured to adjust at least one from among a power switch and an intensity of a light based on the sensed ambient illumination in the second mode or the third mode.

7. The display apparatus of claim 1, wherein the processor is further configured to provide the mirror function on at least a region of the display based on an approaching distance of the user in the second mode, and adjust a size of the region as the user approaching distance is changed.

8. The display apparatus of claim 1, wherein the processor is further configured to control the display to operate in a fourth mode comprising providing an alarm based on the alarm information received from an external user terminal, and control the display to operate automatically in the first mode in response to the fourth mode being completed.

9. The display apparatus of claim 1, wherein the processor is further configured to, when connected with an external user terminal, control the display to operate in the second mode or the third mode based on a user command input state of the external user terminal.

10. A control method of a display apparatus, the control method comprising:
sensing a user; and
operating, based on sensed values of the user, in one mode from among a first mode, a second mode, and a third mode,
wherein the first mode comprises outputting information-providing content on a display, the second mode comprises providing a mirror function on the display, and the third mode comprises providing a user interface (UI) screen in which user interaction is performed.

11. The control method of claim 10, wherein the second mode comprises providing passive content on a region of the display and providing the mirror function on another region of the display, and
the third mode comprises providing the UI screen comprising active content on a region of the display and providing the mirror function on another region of the display.

12. The control method of claim 10, wherein the sensing the user comprises sensing an approaching speed of the user, and
operating in the first mode when the sensed approaching speed is less than a preset threshold speed, and operating in the second mode or the third mode when the sensed approaching speed is greater than or equal to the preset threshold speed.

13. The control method of claim 12, wherein the controlling the output state of the display comprises operating in the first mode when at least one from among a duration of sensing the user and a duration of using the display is less than a preset threshold time, and operating in the second mode or the third mode when at least one from among the duration of sensing the user and the duration of using the display is greater than or equal to the preset threshold time.

14. The control method of claim 10, wherein the sensing the user comprises sensing values of at least one from among a current position of the user, a position change of the user, an approaching speed of the user, an action of the user, a duration of sensing the user and a duration of using the display, and
the controlling the output state of the display comprises operating in one of the first to third modes based on the sensed values.

15. The control method of claim 14, further comprising:
sensing ambient illumination; and
adjusting at least one from among a power switch and an intensity of a light based on the sensed ambient illumination in the second mode or the third mode.

16. The control method of claim 10, further comprising providing a mirror function on at least a region of the display based on the user approaching distance in the second mode, and adjusting a size of the region as the user approaching distance is changed.

17. The control method of claim 10, further comprising operating in a fourth mode comprising providing an alarm based on the alarm information received from an external user terminal, and operating automatically in the first mode in response to the fourth mode being completed.

18. The control method of claim 10, further comprising, when connecting with an external user terminal, operating in the second mode or the third mode based on a user command input state of the external user terminal.
